(19) United States
(12) Patent Application Publication
(10) Pub. No.: US 2021/0117864 A1
(43) Pub. Date: Apr. 22, 2021

(54) OPTIMIZING AI/ML MODEL TRAINING FOR INDIVIDUAL AUTONOMOUS AGENTS

(71) Applicants: John Charles Weast, Phoenix, AZ (US); Rajesh Poornachandran, Portland, OR (US); Hassnaa Moustafa, Portland, OR (US); Rita H. Wouhaybi, Portland, OR (US); Francesc Guim Bernat, Barcelona (ES); Marcos E. Carranza, Portland, OR (US)

(72) Inventors: John Charles Weast, Phoenix, AZ (US); Rajesh Poornachandran, Portland, OR (US); Hassnaa Moustafa, Portland, OR (US); Rita H. Wouhaybi, Portland, OR (US); Francesc Guim Bernat, Barcelona (ES); Marcos E. Carranza, Portland, OR (US)

(21) Appl. No.: 17/133,075

(22) Filed: Dec. 23, 2020

(51) Int. Cl. G06N 20/00; G06N 5/04; G06K 9/62; G06F 21/53; G06F 21/62

(52) U.S. Cl. CPC G06N 20/00; G06N 5/043; G06F 21/6254; G06K 9/6215; G06F 21/53; G06K 9/6256

(57) ABSTRACT

Various systems and methods for customizing training data for an artificial intelligence (AI) or machine-learning (ML) model are disclosed. A set of data is identified from a plurality of sets of data used to train the AI or ML model. The set of data is identified based on a set of metadata associated with the set of data indicating an association between the set of data and a jurisdiction of a digital services tax (DST). Based on the identifying, the plurality of sets of data is modified by removing or reducing reliance upon the set of data. The AI or ML model is retrained based on the modified plurality of sets of data. The retrained AI or ML model is provided for deployment in an individual autonomous agent.

### TECHNICAL FIELD

Embodiments described herein generally relate to training of artificial intelligence (AI) or machine-learning (ML) models for automated systems, and, in one particular embodiment, to optimizing such training to minimize impacts of digital services taxes on use of such models in individual autonomous agents.

### BACKGROUND

A digital services tax (DST) is a tax applied to companies in the digital service industry. For example, the Organisation for Economic Co-operation and Development (OECD) and European Commission aim to tax products and services that utilize information gained from users in one region to deliver products and services in another region. In theory, a DST could be applied to almost any kind of data that is collected or learned from operation in one jurisdiction and used to inform deployment in other jurisdictions. For example, a DST could be applied to data pertaining to user engagement in a social media service in one country that helps prioritize placement of ads or articles to similar profiled users in another country. Or a DST could be applied to data pertaining to design and performance of automated vehicles that is collected or learned from operation in one region and then used to inform deployment in other regions.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to control a vehicle, according to an embodiment;

FIG. 2 is a block diagram of an example method for optimizing training data used in AI/ML models with respect to DSTs;

FIG. 3 is a block diagram depicting an example base station used to enforce DSTs;

FIG. 4 is block diagram depicting an example of distribution of policy management across different entities including a base station and an individual autonomous agent;

FIG. 5 is block diagram depicting an example method of a credentials provisioning flow;

FIG. 6 is an example method of an attestation flow;

FIG. 7 depicts a method of a DST flow with block chain support;

FIG. 8 illustrates the training and use of a machine-learning program or agent, such as one or more programs based on an AI or ML, according to some example embodiments; and

FIG. 9 is a block diagram illustrating an example machine upon which any one or more of the techniques (e.g., methodologies) discussed herein may perform, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

The embodiments ensure traceability of data sets capture for mapping or for AI/ML models and enforcement of their use (e.g., for purposes of optimizing tax implications of current or future DSTs). For example, the disclosed embodiments provide novel approaches for working with DSTs determined to be adopted or expected to be adopted by regulatory bodies around the world.

In example embodiments, metadata is added (e.g., through various mechanisms that together are immune from manipulation) to the data itself. In example embodiments, a tracking and attestation system is defined to optimize and track the use of the data for taxation reporting purposes.

Unlike existing solutions, which require starting from scratch with data collection all over again for a particular application (e.g., because their training data sets do not have traceability based on where the data was gathered for purposes of ensuring any model trained with that data is restricted to use only in the region where the training data was originally collected), the disclosed embodiments are configured to differentiate between unregulated vs. regulated training material, allowing models to be deployed at scale without triggering potentially costly DSTs. In example embodiments, an audit trail is generated (e.g., via a block chain) for a set of data. In example embodiments, the audit trail may be used to indicate to a government whether an entity owes a DST to the government for use of the set of data, such as for use in training of AI/ML models. In example embodiments, a probability that a particular set of data will become regulated or unregulated is calculated. Based on the probability, the set of data may be flagged for removal or reduction in use.

In example embodiments, various systems and methods for customizing training data for an AI or ML model are disclosed. A set of data is identified from a plurality of sets of data used to train the AI or ML model. The set of data is identified based on a set of metadata associated with the set of data indicating an association between the set of data and a jurisdiction of a digital services tax (DST). Based on the identifying, the plurality of sets of data is modified by removing the set of data, reducing the set of data, or reducing weights or influence values associated with the set of data. The AI or ML model is retrained based on the modified plurality of sets of data. The retrained AI or ML model is provided for deployment in an individual autonomous agent. In example embodiments, the identifying of the set of metadata is based on a change being detected in the DST. In example embodiments, a traceable receipt or certificate travels with the retrained model for verification of the modification and/or the set of data (e.g., with respect to origins of each data point in the set of data or the plurality of sets of data).

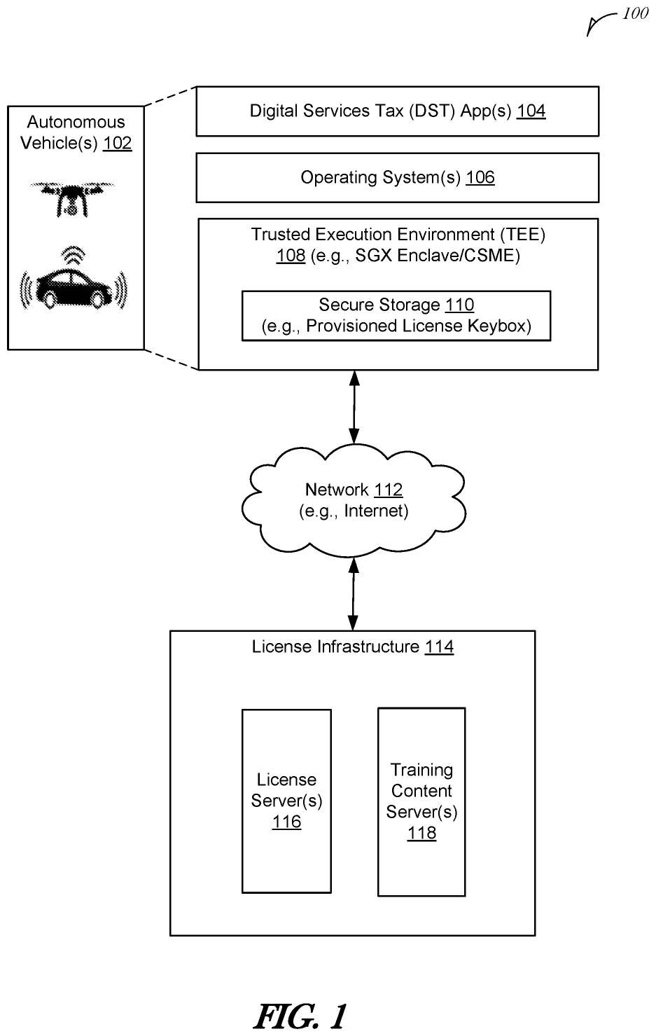

FIG. 1 is a schematic drawing illustrating a system 100 for optimizing use of data for training of AI/ML models with respect to DSTs.

One or more autonomous vehicle(s) or autonomous agents 102 may be of one or more types of vehicles, such as a commercial vehicle, a consumer vehicle, a recreation vehicle, a car, a truck, a motorcycle, a drone, or a boat, able to operate at least partially in an autonomous mode. Each of the vehicle(s) 102 may operate at some times in a manual mode where the driver operates the vehicle conventionally using pedals, steering wheel, and other controls. At other times, the vehicle may operate in a fully autonomous mode, where the vehicle operates without user intervention. In addition, the vehicle may operate in a semi-autonomous mode, where the vehicle controls many of the aspects of driving, but the driver may intervene or influence the operation using conventional (e.g., steering wheel) and non-conventional inputs (e.g., voice control).

In example embodiments, the vehicle includes a sensor array, which may include various forward, side, and rearward facing cameras, radar, LIDAR, ultrasonic, or similar sensors. Forward-facing is used in this document to refer to the primary direction of travel, the direction the seats are arranged to face, the direction of travel when the transmission is set to drive, or the like. Conventionally then, rear-facing or rearward-facing is used to describe sensors that are directed in a roughly opposite direction than those that are forward or front-facing. It is understood that some front-facing camera may have a relatively wide field of view, even up to 180-degrees. Similarly, a rear-facing camera that is directed at an angle (perhaps 60-degrees off center) to be used to detect traffic in adjacent traffic lanes, may also have a relatively wide field of view, which may overlap the field of view of the front-facing camera. Side-facing sensors are those that are directed outward in any direction from the sides of the vehicle, including left, right, back, rear, top, and bottom sides. Cameras in the sensor array may include infrared or visible light cameras, able to focus at long-range or short-range with narrow or large fields of view.

In example embodiments, the vehicle includes an on-board diagnostics system to record vehicle operation and other aspects of the vehicle's performance, maintenance, or status. The vehicle may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

In operation, the vehicle obtains sensor data via sensor array interface from forward-facing sensors to detect an obstacle or potential collision hazard. The forward-facing sensors may include radar, LIDAR, visible light cameras, or combinations. Radar is useful in nearly all weather and longer range detection, LIDAR is useful for shorter range detection, cameras are useful for longer ranges but often become less effective in certain weather conditions, such as snow. Combinations of sensors may be used to provide the widest flexibility in varying operating conditions.

The vehicle controller subsystem may be installed as an after-market component of the vehicle, or may be provided as a manufacturer option. As an after-market component, the vehicle controller subsystem may plug into the existing ADAS in the vehicle to obtain sensor data and may provide the warning lights. Alternatively, the vehicle controller subsystem 102 may incorporate its own sensor array to sense following vehicles.

In example embodiments, the one or more autonomous vehicles 102 includes one or more applications 104 for which a DST may apply. In example embodiments, the one or more applications are installed on one or more operating system(s) 106 executing in a trusted execution environment (TEE) 108. In example embodiments, the TEE 108 includes a secure storage 110, such as a provisioned license keybox.

In example embodiments, the autonomous vehicle(s) 102 or subsystems of the autonomous vehicle(s) 102 may communicate using a network 112, which may include local-area networks (LAN), wide-area networks (WAN), wireless networks (e.g., 802.11 or cellular network), the Public Switched Telephone Network (PSTN) network, ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

In example embodiments, the autonomous vehicle(s) 102 communicate over the network 112 with a license infrastructure 114. In example embodiments, the license infrastructure 114 includes a license server 116 and a training content server 118. In example embodiments, the training content server(s) 118 are configured to train one or more AI or ML models for deployment in the autonomous vehicle(s) 102. In example embodiments, the license server(s) 116 are configured to identify any licensing or DST requirements associated with the data used by the training content server(s) 118 and to optimize the training data to minimize DSTs, as described in more detail below.

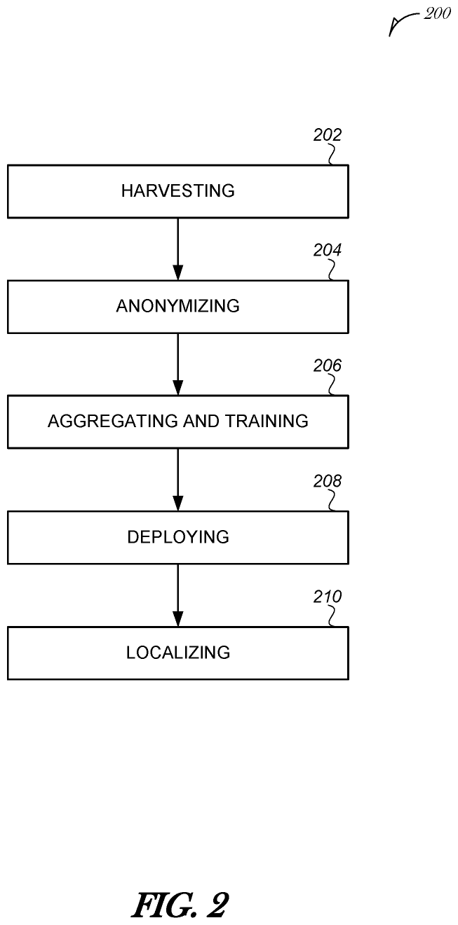

FIG. 2 is a block diagram of a method 200 for optimizing training data used in AI/ML models with respect to DSTs for deployment in an autonomous vehicle. In example embodiments, the operations of the method 200 are implemented by one or more components of the license infrastructure 114 of FIG. 1. At operation 202, data used for training one or more AI or ML models is harvested. For example, the data is harvested from a secure storage in one or more of the vehicle(s) 102 during operation of those vehicles in a specific government jurisdiction. In example embodiments, the data may include data collected from sensors of the vehicle during operation of the vehicle.

During the harvesting of the data, the data is tagged with metadata, such as one or more of a geo-location tag, date, time, day of week, a number of humans nearby, data pertaining to a type of a location of the harvesting, and so on. In example embodiments, the metadata may include any data pertaining to the location of the harvesting of the data that is identified as being relevant to whether a DST will be applied and/or an amount of the DST. For example, day of week and time metadata may be relevant to surge pricing of DSTs, such as when a DST is applied Monday-Friday from 9-5 pm (e.g., based on a judgment that weekday data is more valuable than weekend data). In example embodiments, the metadata is stored with and/or associated with the harvested data. In example embodiments, the geo-location tag or other location-related metadata may define a geographical area (e.g., that is delimited with a set of points). In example embodiments, the location-related metadata may be identified as corresponding to a region or a country. In example embodiments, the location-related metadata may define a type of the location (e.g., urban versus countryside). In example embodiments, such location-related metadata is added to every piece of training data so that there is traceability from data collection for training through deployment of that model for commercial purposes. In example embodiments, every tag and training data is signed by the entity that generates it. In this way, the entity that generated the data may be validated and it may be validated that the tag has not been tampered with. In example embodiments, the content being generated can be attached to a DRM license managed by each jurisdiction (e.g., including a government or corporation, such as an original design manufacturer (ODM)) to enforce that specific data with specific tags are used in the right place. In example embodiments, depending on a tax agreement with a country, the country may be banned from using certain data or an amount of use of that certain data by the country may be restricted. Alternatively, this could be done by using geographic based certificates that sign the data using a certificate issued by the controlling government.

In example embodiments, correlations among the different streams are identified during training based on either different streams from different geographies or augmenting one stream with others that are from tax-enabled geographies. In this way, it can be characterized how free data gets enriched with not-free data. In example embodiments, different models are created, but the ones that require payment are geo-tagged and signed with a data provenance token to allow for traceability for usage that leads to payment.

In example embodiments, estimation ahead of time of cost associated with using a particular model is generated. For example, someone who decides they want the premium package which includes restaurant recommendation for a trip to France, can get an estimate that uses their history (or histories of similar users, such as friends, family, or people having similar profiles), the model they want to use, and other context of the trip (such as cities and length of stay) to provide them a quote for such a service. In example embodiments, data sets and/or models are updated and combined dynamically when previously separate countries reach new agreements that change or link their tax policies.

At operation 204, the harvested data is anonymized (e.g., such that a particular vehicle or driver cannot be identified from the data). In example embodiments, the harvested data is completely secured (e.g., using a data security protocol or system) such that only those with the proper access permission can access the harvested data. In example embodiments, the anonymization of the data and/or the securing of the data may be implemented in accordance with policies that are specific to the government jurisdiction at the location where the data was harvested or where it may be used.

At operation 206, the harvested and anonymized data is organized by region in which the data was collected. In example embodiments, the data is then selected for inclusion in training data for one or more AI/ML models (e.g., that are deployed within one or more of the autonomous vehicle(s) 102) based on one or more factors. In example embodiments, the factors include the cost of using the data (e.g., based on DSTs associated with jurisdictions in which the data was collected or where it will be used), the relative benefit of the data for training the AI/ML models (e.g., in comparison to data organized associated with other regions), and so on. In example embodiments, only unregulated data (e.g., from jurisdictions not having a DST) may be selected for training of ML models. In example embodiments, the unregulated data may be combined with regulated data (e.g., in order of DST amount) until one or more thresholds or criteria are satisfied, such as an amount of data reaching a minimum amount or a cost of DST not exceeding a maximum amount. In example embodiments, the regulated data is used in order of a cost-to-benefit analysis, such as a cost of using the regulated data versus a benefit of increasing an accuracy of an AI model that is trained with the data. In example embodiments, the costs and benefits of using data from each jurisdiction may be presented in an administrative user interface to assist an operator in making a selection of an acceptable combination of unregulated and regulated data. In example embodiments, machine learning of administrative actions with respect to the user interface may enable automatic determinations of appropriate costs and benefits of including regulated data in a training data set for one or more AI/ML models. In example embodiments, publicly available data sets (e.g., stored in a publicly accessible database) may be searched for replacement data sets for any removed data sets or reduced data sets. In example embodiments, data sets having a similarity to the data set that is to be replaced are identified. The similarity may relate between the replacement data and the original data with respect to a type or structure of the data itself or to an impact on an accuracy of the model that is trained with the data.

At operation 208, one or more trained AI/ML models are deployed (e.g., within the one or more autonomous vehicle(s) 102).

At operation 210, the one or more AI/ML models are enabled or disabled based on a location of the vehicle to enforce restrictions and/or implement rights of use pertaining to the AI/ML models when going inside or outside of designated regions. Thus, for example, a baseline AI/ML model having been trained with no regulated data or trained with reduced regulated data may be enabled within an autonomous vehicle when the autonomous vehicle enters a jurisdiction as a replacement for a different AI/ML model (having been trained with a greater amount regulated data) (e.g., to avoid an unfavorable DST impact). In example embodiments, the replacement of the model may be performed on the fly (e.g., as the vehicle moves from one jurisdiction to another).

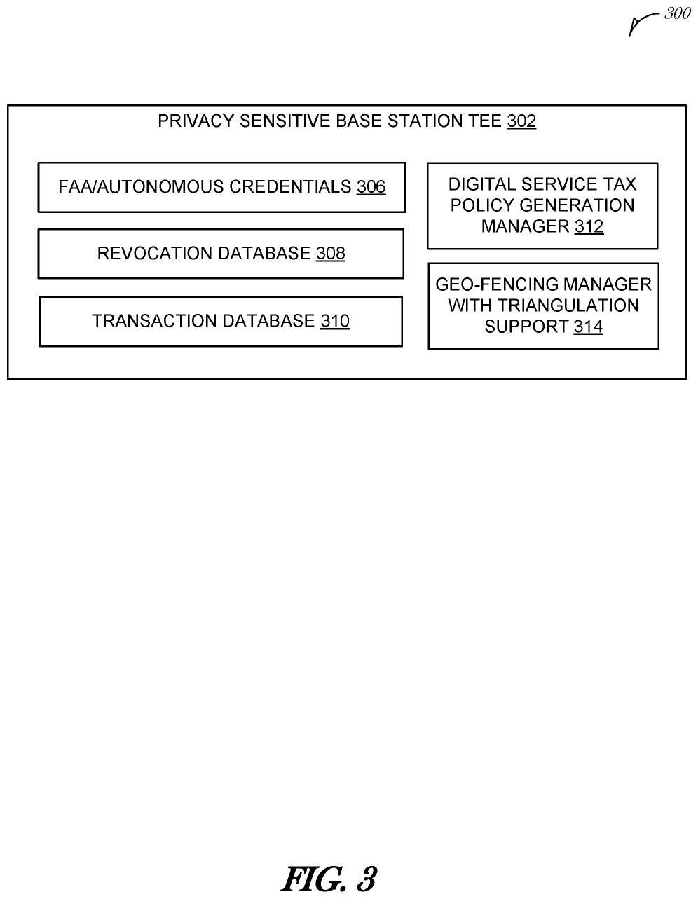

FIG. 3 is a block diagram of a system 300 for a base station. In example embodiments, the base station comprises a privacy sensitive base station TEE 302 that is configured to implement DST enforcement (e.g., in a specific region or governmental jurisdiction). An FAA/autonomous credentials module 306 is configured to manage provisioning of the base station with credentials, such as FAA and manufacturer certificates. A revocation database 308 is configured to determine whether credentials have been revoked by a governmental body. A transaction database 310 is configured to generate a transaction (e.g., for inclusion in a block chain) of use of data within a geographical area. A DST policy generation manager 312 is configured to implement a policy-based action if an individual autonomous agent cannot comply with a requested policy or enforce the requested policy. A geo-fencing manager 314 is configured to provide an attestation response token that includes DST content sharing polices in a geo-fenced restricted zone that is to be enforced via the TEE.

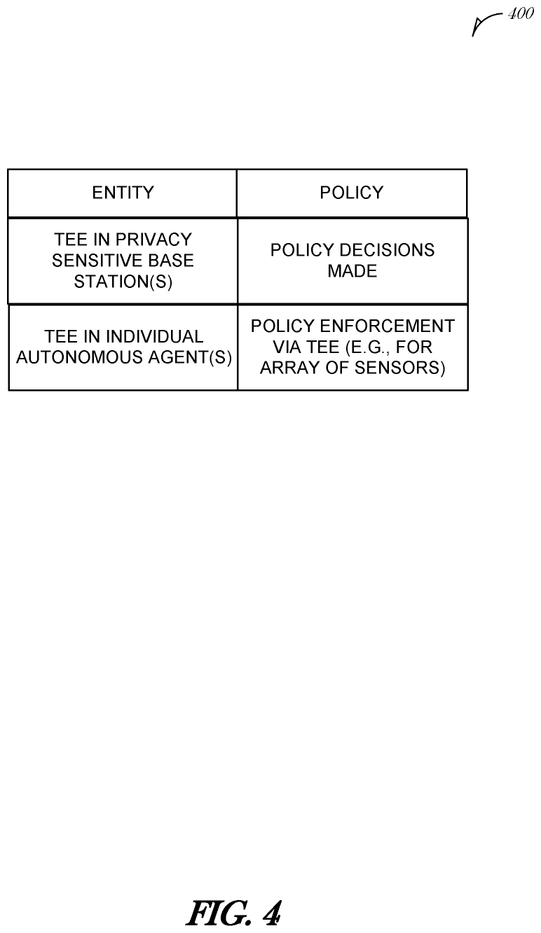

FIG. 4 is an example of distribution of policy management 400 across different entities. As shown, a TEE in one or more privacy sensitive base stations makes policy decisions. A TEE in individual autonomous agent(s) enforces the policies via the TEE (e.g., for an array of sensors).

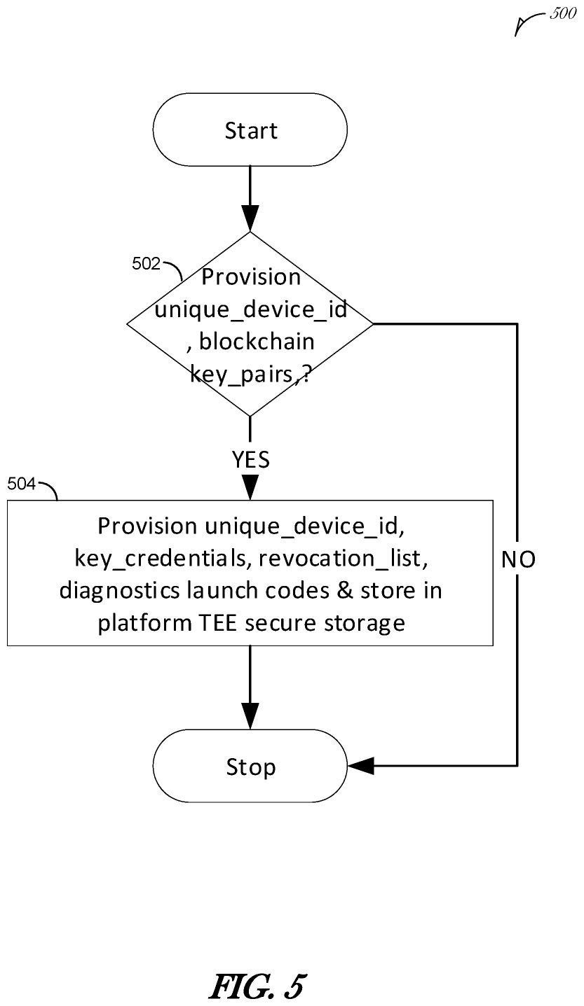

FIG. 5 is an example method 500 of a credentials provisioning flow. In example embodiments, individual autonomous agents (e.g. drones/vehicles) and respective geographical base-stations are provisioned with appropriate credentials (such as FAA and manufacturer certificates). In example embodiments, the provisioning occurs during manufacturing or via over-the-air (OTA) provisioning. At operation 502, it is determined whether a device (e.g., an autonomous vehicle) is to be provisioned with respect to the base station. At operation 504, based on the determination at step 502, various data pertaining to the device is stored in secure storage of a TEE. This data may include a unique device identifier, key credentials, a revocation list, diagnostic launch codes, and so on.

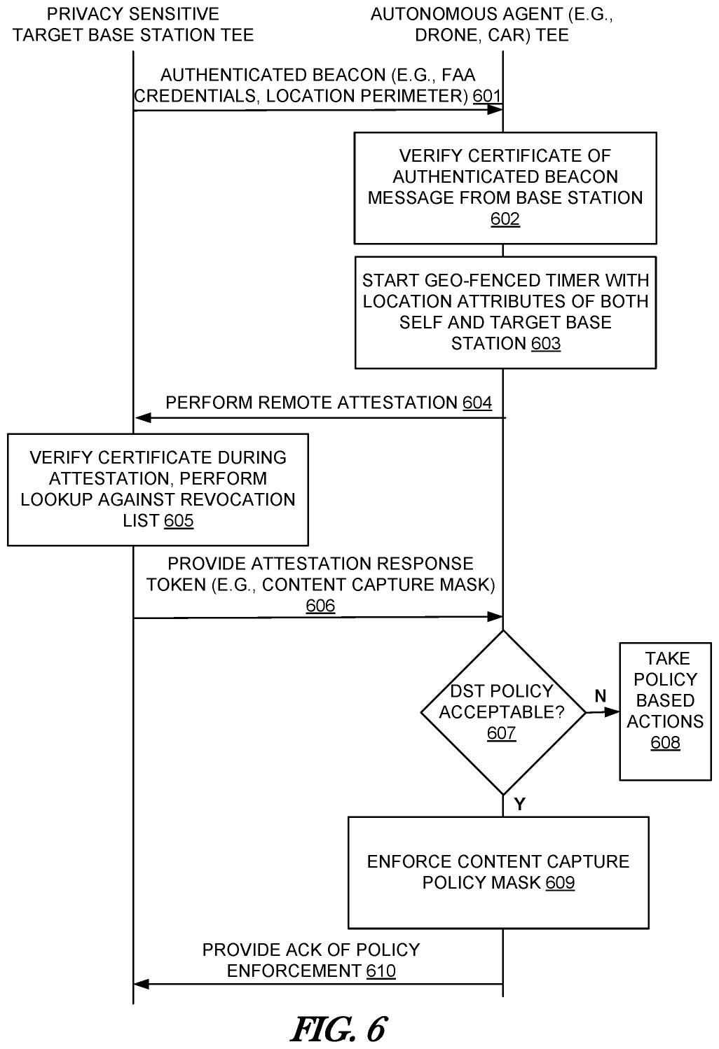

FIG. 6 is an example method 600 of an attestation flow. At operation 601, a privacy sensitive base station (BS) sends an authenticated Beacon (e.g., that includes its FAA certificate, location, and/or a restricted perimeter zone).

At operation 602, a TEE in individual autonomous agents verify the authenticated beacon from base station.

At operation 603, the TEE in the individual autonomous agents (AA) start geo-fenced timer (e.g., that includes its 3D orientation context, location attributes of itself, and/or the target base station).

At operation 604, the BS and AA perform remote attestation for mutual verification using respective TEEs.

At operation 605, the BS verifies AA credentials and checks against its revocation data base.

At operation 606, the BS provides attestation response token that includes DST content sharing policies in the geo-fenced restricted zone to be enforced via TEE in IDs.

At operation 607, the AAs check if the requested policies can be securely enforced.

At operation 608, if AAs cannot comply, policy based action can be taken.

At operation 609. if AAs can comply with the content capture mask, they enforce the requested policy constraints.

At operation 610, AAs provide acknowledgement to the token issued by the BS for the specific session.

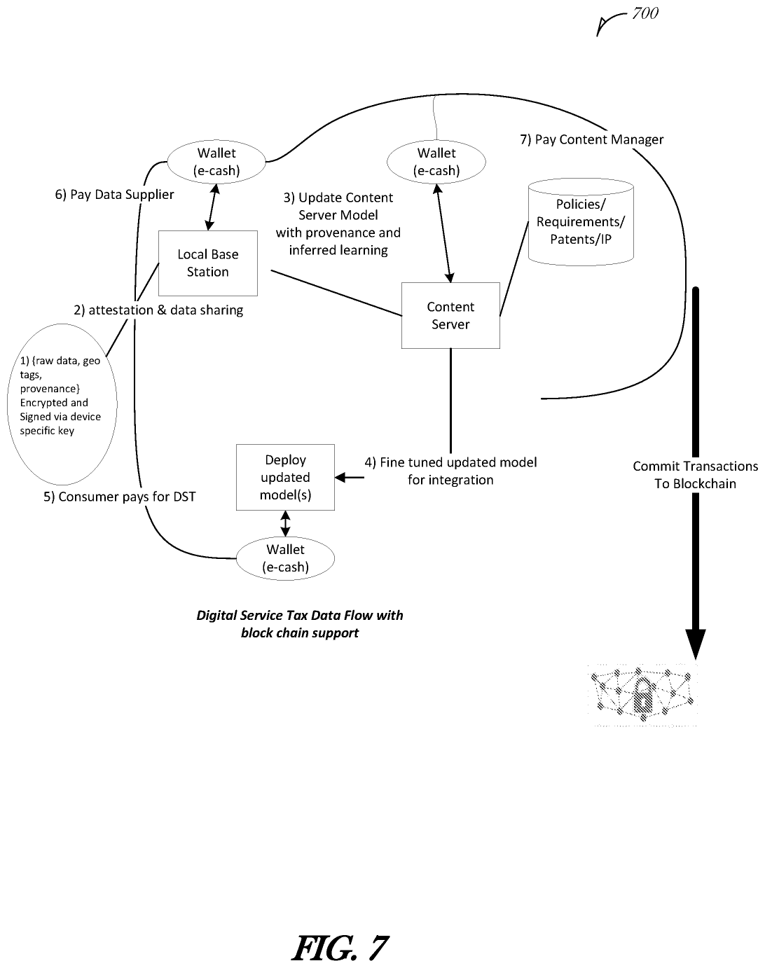

FIG. 7 depicts a method 700 of a DST flow with block chain support. At 1, raw harvested data, geo-tags, and/or provenance data is encrypted and signed via a device-specific key.

At 2, attestation and data sharing occurs (e.g., as shown in FIG. 6).

At 3, a content server model is updated with provenance and inferred learning.

At 4, the updated model is fine tuned for integration into an AA.

At 5, consumer pays for DST (e.g., via e-cash wallet)

At 6, a data supplier receives payment.

At 7, a content manager receives payment and the transaction is committed to a blockchain.

In example embodiments, machine learning for fine-grained data tagging is implemented. The training data is tagged with scene description to show multiple features to help the decision on regulated versus un-regulated data. Examples: (1) Data collected on a highway in country1/region1 that is a common highway with country2/region2 can be regulated data that does not need taxation in country2/region2; (2) Data relative to safe driving (e.g., data including traffic signs) may not be subject to taxation; (3) Data pertaining to pedestrians may be regulated or unregulated in some regions based on privacy laws.

In example embodiments, multi-feature data tagging is used to reflect road geography, pedestrian presence, fine-grained location/region, traffic signs presence, and so on, such as through sensed data or map that represents the ground truth. In example embodiments, Machine Learning (ML) is applied to the collected training data considering Multi-Class and Multi-Label Classification (where # of Classes=# of the intended features). Multi-Class Classifications detects the data samples belonging to each Class (e.g., each intended feature). Multi-Label Classification detects the data samples that belong to multiple Classes (i.e., more than one intended feature).

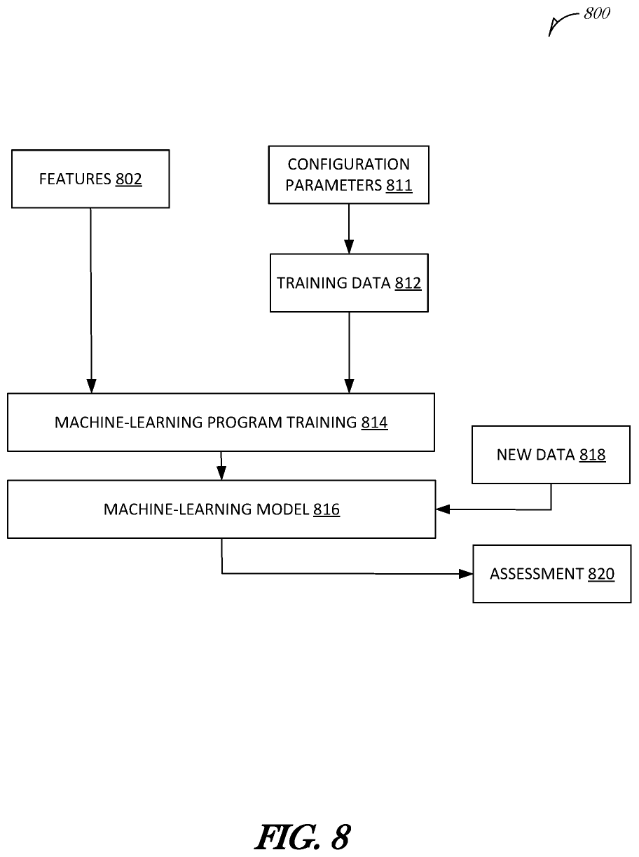

FIG. 8 illustrates the training and use of a machine-learning program or agent, such as one or more programs based on an AI or ML model, according to some example embodiments. In some example embodiments, machine-learning programs (MLPs), also referred to as machine-learning algorithms or tools, are utilized to perform autonomous driving (AD).

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 816 from example training data 812 in order to make data-driven predictions or decisions expressed as outputs or assessments 820. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

In example embodiments, there are two modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

In example embodiments, supervised ML tasks include classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

In example embodiments, unsupervised ML tasks include clustering, representation learning, and density estimation. Some examples of commonly used unsupervised-ML algorithms are K-means clustering, principal component analysis, and autoencoders.

The training data 812 comprises examples of values for the features 802. In some example embodiments, the training data comprises labeled data with examples of values for the features 802 and labels indicating the outcome, such as am assessment of a driver's behavior. The machine-learning algorithms utilize the training data 812 to find correlations among identified features 802 that affect the outcome. A feature 802 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as numeric features, strings, and graphs.

In one example embodiment, the features 802 may be of different types and may include one or more of vehicle sensor array data, vehicle driving commands, or context data (e.g., a type of location, such as an intersection, that is inferred from sensor data, such as GPS coordinates; vehicle driving policy data, or other data inferred from the type of the location, time of day, or other metadata relevant to a context of an operation of the vehicle, such as risk data associated with operating the vehicle, or metadata pertaining to whether a DST is applicable or an amount of a DST with respect to particular data points in a data set).

During training 814, the ML algorithm analyzes the training data 812 based on identified features 802 and configuration parameters 811 defined for the training. The result of the training 814 is an ML model 816 that is capable of taking inputs to produce assessments. In example embodiments, one or more sets of training data are selected from a plurality of candidate sets of training data to minimize impact on DSTs, as described herein. For example, one or more sets of training data are excluded or reduced from the plurality of candidate sets based on a detection of a change to a DST, such as DST that applies to a source of the data or a use of the data, as described herein. Each data point and/or data set may be associated with metadata that allows for traceability of source and/or usage of the data, as described herein.

Training an ML algorithm involves analyzing large amounts of data (e.g., from several gigabytes to a terabyte or more) in order to find data correlations. The ML algorithms utilize the training data 812 to find correlations among the identified features 802 that affect the outcome or assessment 820. In some example embodiments, the training data 812 includes labeled data, which is known data for one or more identified features 802 and one or more outcomes, such as a determination of a driving command that is to be issued to a vehicle to autonomously control the vehicle.

The ML algorithms usually explore many possible functions and parameters before finding what the ML algorithms identify to be the best correlations within the data; therefore, training may make use of large amounts of computing resources and time.

In example embodiments, some ML algorithms may include configuration parameters 811, and the more complex the ML algorithm, the more parameters there are that are available to the user. The configuration parameters 811 define variables for an ML algorithm in the search for the best ML model. The training parameters include model parameters and hyperparameters. Model parameters are learned from the training data, whereas hyperparameters are not learned from the training data, but instead are provided to the ML algorithm.

Some examples of model parameters include maximum model size, maximum number of passes over the training data, data shuffle type, regression coefficients, decision tree split locations, and the like. Hyperparameters may include the number of hidden layers in a neural network, the number of hidden nodes in each layer, the learning rate (perhaps with various adaptation schemes for the learning rate), the regularization parameters, types of nonlinear activation functions, and the like. Finding the correct (or the best) set of hyperparameters can be a very time-consuming task that makes use of a large amount of computer resources.

When the ML model 816 is used to perform an assessment, new data 818 is provided as an input to the ML model 816, and the ML model 816 generates the assessment 820 as output.

Feature extraction is a process to reduce the amount of resources required to describe a large set of data. When performing analysis of complex data, one of the major problems is one that stems from the number of variables involved. Analysis with a large number of variables generally requires a large amount of memory and computational power, and it may cause a classification algorithm to overfit to training samples and generalize poorly to new samples. Feature extraction includes constructing combinations of variables to get around these large-data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or a similar, amount of information.

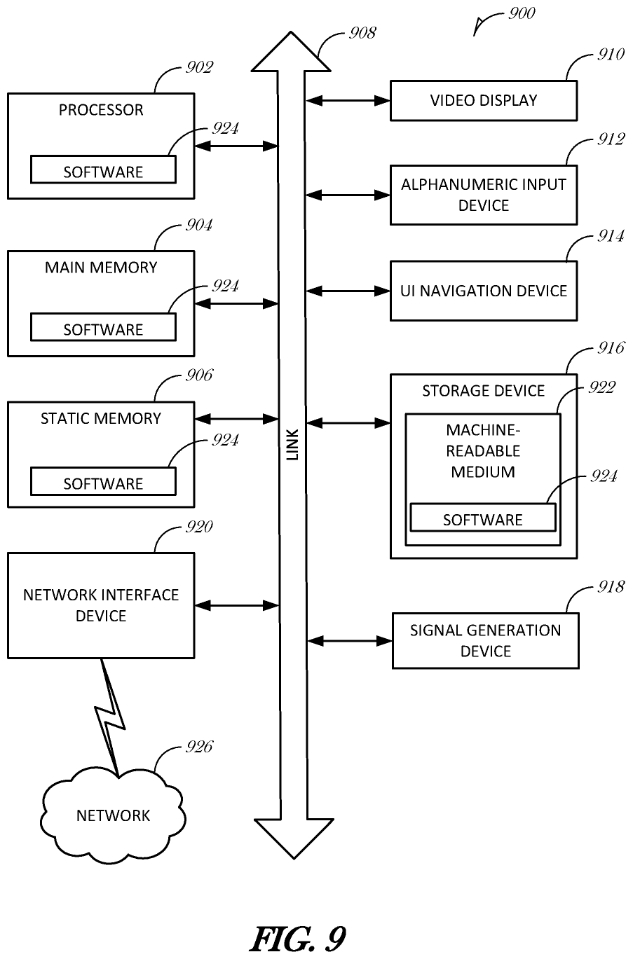

FIG. 9 is a block diagram illustrating a machine in the example form of a computer system 900, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a head-mounted display, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, gyrometer, magnetometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
one or more computer processors;
one or more computer memories;
a set of instructions incorporated into the one or more computer memories, the set of instructions configuring the one or more computer processors to perform operations comprising:
harvest data from an autonomous agent in a jurisdiction, wherein the data comprises location of the first jurisdiction;
anonymize the harvested data to secure the data based on the location;
deploy a machine learning model to the autonomous agent;
enable or disable the machine learning model in the autonomous agent based on whether the location of the autonomous agent is within or outside the jurisdiction.

2. The system of claim 1, wherein anonymize the harvested data comprises identifying a set of data from a plurality of sets of data used to train an artificial intelligence (AI) model, the identifying of the set of data based on a set of metadata associated with the set of data indicating an association between the set of data and a jurisdiction of a digital services tax (DST);
based on the identifying, modifying the plurality of sets of data by removing or reducing reliance upon the set of data;
retraining the AI model based on the modified plurality of sets of data; and
wherein deploy a machine learning model to the autonomous agent comprises providing the retrained AI model for deployment in an autonomous agent.

3. The system of claim 2, further comprising: identifying an additional set of data having based on a similarity between the additional set of data and the set of data and wherein the modifying of the plurality of sets of data includes adding the additional set of data to the plurality of sets of data.

4. The system of claim 3, wherein the identifying of the additional set of data is further based on a set of metadata associated with the additional set of data indicating a lack of association between the additional set of data and the jurisdiction of the DST.

5. The system of claim 2, wherein the metadata includes one or more location metadata items that are generated by one or more DST applications executing in one or more trusted execution environments (TEEs) of a plurality of additional individual autonomous agents when the set of data is harvested by the plurality of additional individual autonomous agents.

6. The system of claim 4, wherein the set of data is anonymized according to a policy of a jurisdiction in which the set of data was harvested.

7. The system of claim 6, wherein the policy of the jurisdiction is stored in a TEE of a privacy sensitive base station and the policy is enforced by the one or more DST applications.

8. The system of claim 7, wherein an acknowledgment of the policy enforcement is transmitted to the base station based a determination by the one or more DST applications that the policy is acceptable.

9. A system comprising:
means for harvesting data from an autonomous agent in a jurisdiction, wherein the data comprises location of the first jurisdiction;
means for anonymizing the harvested data to secure the data based on the location;
means for deploying a machine learning model to the autonomous agent;
means for enabling or disabling the machine learning model in the autonomous agent based on whether the location of the autonomous agent is within or outside the jurisdiction.

10. The system of claim 9, wherein anonymizing the harvested data comprises identifying a set of data from a plurality of sets of data used to train an artificial intelligence (AI) model, the identifying of the set of data based on a set of metadata associated with the set of data indicating an association between the set of data and a jurisdiction of a digital services tax (DST);
based on the identifying, modifying the plurality of sets of data by removing or reducing reliance upon the set of data;
retraining the AI model based on the modified plurality of sets of data; and
wherein deploy a machine learning model to the autonomous agent comprises providing the retrained AI model for deployment in an autonomous agent.

11. The system of claim 9, further comprising means for identifying an additional set of data based on a similarity between the additional set of data and the set of data or based on a similarity between an impact of the additional set of data and the set of data on an accuracy of the AI model and wherein the modifying of the plurality of sets of data includes adding the additional set of data to the plurality of sets of data.

12. The system of claim 11, wherein the identifying of the additional set of data is further based on a set of metadata associated with the additional set of data indicating a lack of association between the additional set of data and the jurisdiction of the DST.

13. The system of claim 12, wherein the metadata includes one or more location metadata items that are generated by one or more DST applications executing in one or more trusted execution environments (TEEs) of a plurality of additional individual autonomous agents when the set of data is harvested by the plurality of additional individual autonomous agents.

14. The system of claim 10, wherein the set of data is anonymized according to a policy of a jurisdiction in which the set of data was harvested.

15. The system of claim 15, wherein the policy of the jurisdiction is stored in a TEE of a privacy sensitive base station and enforcement of the policy is performed by the one or more DST applications.

16. The system of claim 15, wherein an acknowledgment of an enforcement of the policy is transmitted to the base station based a determination by the one or more DST applications that the policy is acceptable.

17. A non-transitory computer-readable storage medium comprising a set of instructions that, when executed by one or more computer processors, causes the one or more computer processors to perform operations comprising:
identifying a set of data from a plurality of sets of data used to train an artificial intelligence (AI) model, the identifying of the set of data based on a set of metadata associated with the set of data indicating an association between the set of data and a jurisdiction of a digital services tax (DST);
based on the identifying, modifying the plurality of sets of data by removing or reducing reliance upon the set of data;
retraining the AI model based on the modified plurality of sets of data; and
providing the retrained AI model for deployment in an individual autonomous agent.

18. The non-transitory computer-readable storage medium of claim 17, wherein anonymize the harvested data comprises identifying a set of data from a plurality of sets of data used to train an artificial intelligence (AI) model, the identifying of the set of data based on a set of metadata associated with the set of data indicating an association between the set of data and a jurisdiction of a digital services tax (DST);
based on the identifying, modifying the plurality of sets of data by removing or reducing reliance upon the set of data;
retraining the AI model based on the modified plurality of sets of data; and
wherein deploy a machine learning model to the autonomous agent comprises providing the retrained AI model for deployment in an autonomous agent.

19. The non-transitory computer-readable storage medium of claim 17, the operations further comprising: identifying an additional set of data having based on a similarity between the additional set of data and the set of data and wherein the modifying of the plurality of sets of data includes adding the additional set of data to the plurality of sets of data.

20. The non-transitory computer-readable storage medium of claim 19, wherein the identifying of the additional set of data is further based on a set of metadata associated with the additional set of data indicating a lack of association between the additional set of data and the jurisdiction of the DST.
